(19) United States
(12) Patent Application Publication
(10) Pub. No.: US 2004/0196540 A1
(43) Pub. Date: Oct. 7, 2004

(54) Semiconductor optical amplifiers

(76) Inventors: Ian Francis Lealman, Ipswich (GB); Gavin Christopher Crow, Woodbridge (GB)

Correspondence Address: CORNING INCORPORATED, SP-TI-3-1, CORNING, NY, 14831

(21) Appl. No.: 10/376,466

(22) Filed: Feb. 28, 2003

(51) Int. Cl. H01S 3/00

(52) U.S. Cl. 359/344

(57) ABSTRACT

A semiconductor optical amplifier has the materials and dimensions of its waveguide chosen to obtain, at an intended working wavelength (say the C band), a confinement factor of less than 0.06 for the most confined mode and mode field diameters in the range from about 3 to about 4 μm for the fundamental T_{E} and T_{M} modes, based on a 1/e mode field boundary, whereby the semiconductor optical amplifier can be readily coupled to a tensed optical fiber without requiring a mode expander or additional optics.

In another aspect, the present invention includes a semiconductor optical amplifier in which the electro-optically active core is constructed as a strained superlattice, as a surprising result of which the manufacturing tolerances in respect of compositions and dimensions required to obtain an acceptably small polarization-dependent gain are substantially less demanding than in the case of a bulk-strained active core.

### BACKGROUND OF THE INVENTION

### FIELD OF THE INVENTION

The present invention relates generally to optical communications, and particularly to semiconductor optical amplifiers.

### TECHNICAL BACKGROUND

As the use of fiber optics expands from its well-established field of long-haul trunk communication lines into metropolitan, access and local area networks, it is increasingly desirable to use compact and relatively inexpensive semiconductor optical amplifiers rather than erbium-doped fiber amplifiers. This desire is often frustrated because current commercial designs of semiconductor optical amplifier

(a) have very small mode fields in the active region requiring the provision of mode size adjusters or expensive optics to couple them efficiently to ordinary optical fibers, resulting in reduced net gain and saturated output power and increased noise figure;

(b) may need expensive multi-layer anti-reflection coatings on their facets to avoid lasing, and

(c) have inherently anisotropic layer structures, which makes it difficult to ensure even approximately equal amplification of different polarization modes.

Equalization of polarization mode gain may require the manipulation both of the amount of active gain material within the respective mode fields and also of the energy levels of the gain material, in order to promote transitions that will preferentially amplify the mode that would otherwise emerge from the device with the lesser gain. It should be noted that a specific inequality of gains between the principal T_{E} and T_{M} modes may be required because they couple to fibers with different efficiencies, and it is the overall fiber-to-fiber gain that needs to be equalized.

Such manipulation requires precise control of the composition, thickness and strain of the active core, which may be almost impossible to achieve over the area of a semiconductor wafer, leading at best to low yields and multiplied costs.

### SUMMARY OF THE INVENTION

This invention is based in part on the recognition by the inventors that these current designs of semiconductor optical amplifier evolved from optimized laser designs and are simply not optimum designs for amplifiers, and in part on the recognition that one of the lesser known types of active core has significant and unexpected advantages in the quest for polarization-insensitive gain.

One aspect of the invention is a semiconductor optical amplifier comprising an optical waveguide; an electro-optically active core within the waveguide; and electrodes for supplying electric current to said electro-optically active core to establish population inversion between energy levels therein enabling amplification of a light signal passing through the waveguide, wherein the materials and dimensions of the waveguide are chosen to obtain, at an intended working wavelength, a confinement factor of less than 0.06 for the most confined mode and mode field diameters in the range from about 3 to about 4 μm for the fundamental T_{E} and T_{M} modes, based on a 1/e mode field boundary, whereby the semiconductor optical amplifier can be readily coupled to a lensed optical fiber without requiring a mode expander.

In another aspect, the present invention includes a semiconductor optical amplifier comprising an optical waveguide; an electro-optically active core within the waveguide; and electrodes for supplying electric current to said electro-optically active core to establish population inversion between energy levels therein enabling amplification of a light signal passing through the waveguide, wherein the materials and dimensions of the waveguide are chosen to obtain, at an intended working wavelength, a confinement factor of less than 0.06 for the most confined mode and mode field diameters in the range from about 3 to about 4 μm for the fundamental T_{E} and T_{M} modes, based on a 1/e mode field boundary, and wherein said electro-optically active core is constructed as a strained superlattice.

Surprisingly, we have found that the manufacturing tolerances in respect of compositions and dimensions required to obtain an acceptably small polarization-dependent gain are substantially less demanding in such device with a strained superlattice active core than in the case of one with a bulk-strained active core.

For avoidance of doubt, it is stated that confinement factors referred to herein are as computed by the commercially available software package known as Fimmwave and available from Photon Design at 34 Leopold Street, Oxford OX4 ITW, Great Britain; the alternative Kymata TempSelene3.2.01 does not always give consistent results.

We prefer that the strained superlattice core has a net tensile strain, and more especially one in which it comprises tensile strained barriers and relatively unstrained quantum-mechanically coupled quantum wells.

The invention further includes assemblies in which the semiconductor optical amplifiers described are coupled directly to at least one lensed optical fiber (and usually two such fibers), without the use of either mode size adjusters or additional optics.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a diagrammatic perspective view of a semiconductor optical amplifier that is an embodiment of the present invention;

FIG. 2 is a an enlarged detail of the active core of the amplifier of FIG. 1;

FIG. 3 is a diagram of an assembly in accordance with the invention; and

FIG. 4 is a graph illustrating how the invention facilitates equalization of gain for different polarization modes.

### DETAILED DESCRIPTION OF THE PREFERRED EMBODIMENTS

The strained superlattice multiple quantum well type of electro-optically active core was originally proposed for the construction of semiconductor lasers (for example, Okamoto et al, TM Mode Gain Enhancement in GaInAs—InP Lasers with Tensile Strained-Layer Superlattice, IEEE Journal of quantum Electronics, Vol 27 no.6, June 1991 (IEEE log # 9100208) and the references cited therein) but has been recognized as potentially useful in mode controlled functional semiconductor devices in general, and has sometimes been used in making semiconductor optical amplifiers for experimental purposes; see for example two papers authored by the senior inventor with other colleagues, Kelly et al, in Electronics Letters, the first in the issue dated 12 Sep. 1996 and entitled Polarisation insensitive, 25 dB Gain semiconductor laser amplifier without antireflection coatings and the second in the issue dated 13 Mar. 1997 and entitled Low noise figure (7.2 dB) and high Gain (29 dB) semiconductor laser amplifier without antireflection coatings. They differ from ordinary multiple quantum well active cores in having the compositions of the well and barrier layers chosen so that they have substantially different lattice parameters, and epitaxially grown on a substrate that will usually but not inevitably be lattice-matched to one of the layer types; the result of this is that the layers of the other type (preferably the barrier layers) are biaxially strained, preferably elongated (tensile strained or loosely “tensioned”). A significant effect of relative strain is that the lower “heavy hole” eigenstates tend to become more localized to the wells and cease to be degenerate with corresponding “light hole” eigenstates. Since the eigenstates have different geometries, the transitions involving them contribute in different proportions to T_{E} and T_{M} gain, and differences in their energy levels can be exploited to achieve (within limits) the desired T_{E}:T_{M} gain ratio.

Reference will now be made in detail to the present preferred embodiments of the invention, examples of which are illustrated in the accompanying drawings. Whenever possible, the same reference numerals will be used throughout the drawings to refer to the same or like parts.

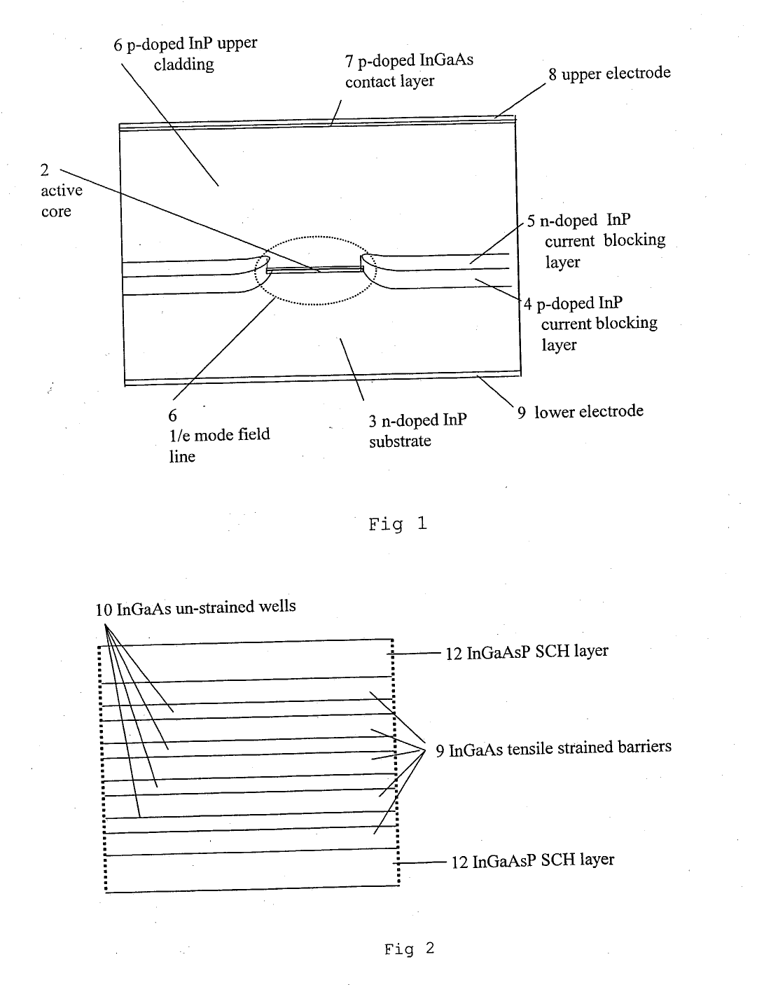

FIG. 1 shows a buried-heterostructure semiconductor optical amplifier 1 in accordance with the invention which comprises an active core 2 formed in the usual way on an n-doped indium phosphide substrate 3 and enclosed laterally by a p-doped indium phosphide layer 4 and an n-doped indium phosphide layer 5 for current-blocking purposes and above by a p-doped indium phosphide cladding layer to form an optical waveguide whose mode-field boundary (based on 1/e of the peak field, where e is the base of natural or Naperian logarithms) is shown as 6.

A thin p-doped indium-gallium arsenide contact layer 7 and upper and lower metal electrodes 8 and 9 complete the amplifier.

As so far described, the amplifier is of conventional construction, but its dimensions and the construction of the active core are not. The layer structure of the active core is shown in an enlarged diagram in FIG. 2 and is made up of about four quantum wells 10 separated and bounded by five barrier layers 11 and sandwiched between two confinement layers 6. The quantum wells are formed of indium gallium arsenide of composition In_{0.53}Ga_{0.47}As so that it has a lattice constant of 0.5869 nm which is close to that of the substrate, so that the wells are without any significant strain. The barrier layers, on the other hand, have the different composition In_{0.435}Ga_{0.565}As, so that its lattice constant in bulk would be 0.5830 nm and in its context as a thin layer epitaxially formed on the substrate it is elongated (“tensile strained”) by about 0.67%. The active core is completed as a symmetric “SCH” structure by upper and lower confinement layers 12, 12 of composition In_{0.72}Ga_{0.28}As_{0.6}P_{0.4} of higher refractive index. Thus the active core has a net tensile strain and the quantum wells are quantum-mechanically coupled: some of the eigenstates (notably the lower of the “heavy hole” states) are markedly localized to the individual wells, while others are not.

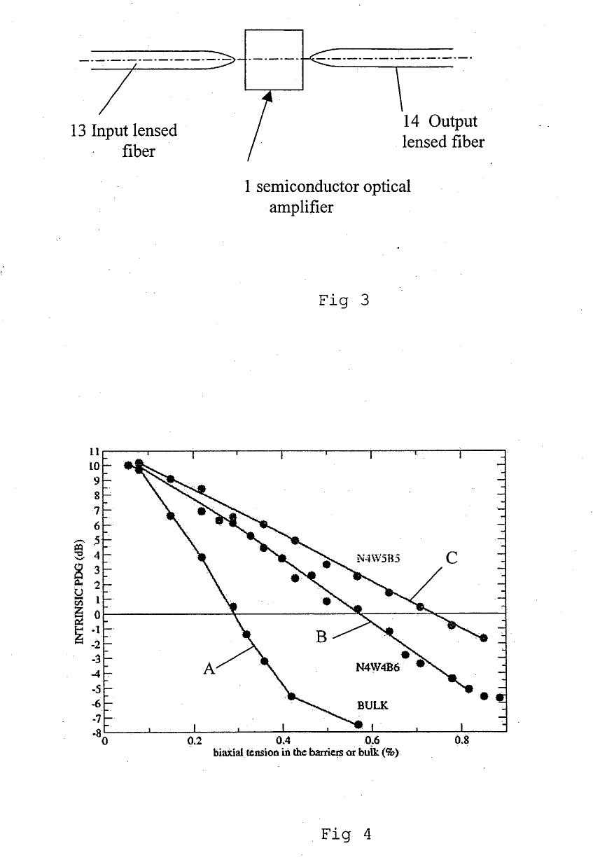

The active core 2 is thin (in the region of 50 nm) and much wider than usual (in the region of 3 μm), whereby the confinement factor for light of wavelength in the range 1528-1565 nm, commonly called the “C band” is lower than 0.06% for the most confined mode and the mode field in this example for each of the fundamental T_{E} and T_{M} modes is somewhat oval with a greatest dimension, based on treating as the boundary 6 the locus of points where the field has a value 1/e times the peak field, of about 3.5 μm, enabling efficient coupling to the lensed fiber(s) 13 and 14 as seen in FIG. 3 without the use of mode size adjusters or of additional optics of any kind.

Omission of mode expanders or optics may eliminate substantial losses and tends to reduce the noise figure of the amplifier and to increase saturation output power. Because the confinement factor is low, the length of the amplifier can be greater with moderate gain, low noise and high power, and the increased area of the device both reduces the amount of current leakage (so improving efficiency, especially at high drive current), which further increases the practical saturation power compared with structures of low confinement but small mode field. It also increases the area available for heat dissipation. Since the width of the optical waveguide is greater than for a conventional semiconductor optical amplifier, the precision required in etching it is lessened as the same error in absolute dimensions is substantially less in proportion to the width (typically one third as great) and yields may be increased. Further, because of the large mode size at the facet, using a facet angled in the usual way (at around 10°), reflection of light back into the guided mode is minimal and only a simple (single-layer) coating is needed, to reduce Fresnel losses—there is no risk of lasing in a semiconductor optical amplifier in accordance with this invention but otherwise of ordinary dimensions.

We believe that four quantum wells (and consequently five barriers) will in most cases be sufficient for the performance of the invention, but the number chosen is potentially an additional variable for adjustment to obtain a desired combination of properties; however, substantially larger numbers are not desirable and very large numbers would be impracticable because of the difficulty of making them correspondingly thin and yet uniform.

### EXAMPLES

The invention will be further clarified by the following examples. It should first be noted that the thicknesses and strains reported are estimated average actual values based on fitting X-ray rocking curves, using the double crystal diffraction technique generally as described, for example, by M A G Halliwell, M R Taylor and T Ambridge in British Telecom Technology Journal 3/3 page 30 (July 1985) and in the textbook X-Ray Scattering from Semiconductors by Paul F Fewster, published by Imperial College Press, London (2000). More specifically, we used a double-crystal diffractometer with a 4-crystal Ge monochromator, supplied by PANalytical (formerly Philips Analytical—www.panalytical.com) using copper K_{α} radiation to collect data for the ω/2θ rocking curve of the (004) reflection of the sample over the approximate range ω=31.7±1°. The collected data was input to fitting software called Philips Analytical X'Pert Smoothfit, which is part of the Philips Analytical X'Pert Epitaxy suite of programs, also available from PANalytical, and the intended dimensions and strains input as a zero'th approximation which the software refined by iterative adjustments to obtain the best fit to the measured data. This technique is expected to give thickness values correct to ±0.2 nm and strain values correct to ±0.05%, and even at this level it was found that some examples differed appreciably from the thickness and/or strain that had been intended; in some cases equally good fit was obtained for two different sets of parameters.

Three series of experimental semiconductor amplifiers were made, each having four quantum wells which were as nearly as possible unstrained (In_{0.53}Ga_{0.47}As) and five barriers with compositions respectively In_{0.435}Ga_{0.565}As, In_{0.415}Ga_{0.585}As and In₀₄₀Ga_{0.60}As corresponding to nominal strains of 0.67%, 0.85% and 1.0% respectively. The confinement layers of In_{0.72}Ga_{0.28}As_{0.6}P_{0.4} were nominally 12 nm thick and the chip length (optical path length in the active core) was 1.6 mm. The nominal width of the waveguide was 3 μm and some 3-5 μm of p-type indium phosphide was formed over the active layer to ensure effective guiding of the desired modes and minimize light absorption in the ternary contact layer. The strain values actually achieved as well as the layer thicknesses were estimated by fitting X-ray rocking curves as described above (and within the limitations of the method), and these estimates are set out in the following table together with the measured overall fiber-to-fiber polarization-dependent gain of the amplifier at 500 mA when prepared with simple single-layer antireflection coatings and properly coupled to two standard singe-mode fibers lens-ended with a mode size optimized to give a full-width half-maximum intensity far-field angle of 16°. It should be noted that only the magnitude of the polarization-dependent gain was measured, its sign being inferred, and that in a number of instances the computation allowed two equally probable interpretations, both of which are reported:

| | | | | | |
|---|---|---|---|---|---|
| | well | barrier | well | barrier | measured |
| | thickness | thickness | compression | tension | PDG(dB) |
| Example | (nm) | (nm) | (%) | (%) | at 500 mA |

nominal barrier tension 0.67%

| | | | | | |
|---|---|---|---|---|---|
| 1 | 4 | 6.7 | 0.033 | 0.63 | 2 |
| 2 | 4 | 6.5 | 0.025 | 0.62 | 1.5 |
| | 3.9 | 6.7 | 0.025 | 0.57₅ | 1.5 |
| 3 | 4.2 | 6 | 0.070 | 0.64 | 3.0₅ |
| 4 | 3 | 7 | 0.010 | 0.63 | 0.8 |
| 5 | 3.1 | 7.7 | 0.015 | 0.63 | 0.3 |
| 6 | 3.4 | 6.9 | 0.020 | 0.62 | 1.6₅ |
| 7 | 3.8 | 7.3 | 0.040 | 0.64 | 1.8₅ |
| 8 | 3.3 | 7 | 0.085 | 0.66 | 0.5 |
| 9 | 3.5 | 7.3 | 0.085 | 0.65 | 0.4 |

nominal barrier tension 0.85%

| | | | | | |
|---|---|---|---|---|---|
| 10 | 4.2 | 6.2 | 0.050 | 0.82 | 0.6 |
| | 4.1 | 6.4 | 0.040 | 0.77 | 0.6 |
| 11 | 5.7 | 5.2 | 0.070 | 0.79 | 4.6₅ |
| | 5.2 | 5.7 | 0.075 | 0.70 | 4.6₅ |
| 12 | 4 | 6 | 0.040 | 0.80 | 1.0₅ |
| 13 | 5.1 | 5 | 0.055 | 0.81 | 4.3 |
| 14 | 4.7 | 6.8 | 0.070 | 0.84 | 1.1₅ |

nominal barrier tension 1.0%

| | | | | | |
|---|---|---|---|---|---|
| 15 | 4.1 | 6.6 | 0.075 | 0.95 | −0.5 |
| | 4.2 | 6.2 | 0.060 | 0.91 | 0.5 |
| 16 | 4.1 | 6 | 0.050 | 0.99 | −0.8 |
| 17 | 4 | 6.6 | 0.075 | 0.92₅ | −0.5₅ |
| | 4.4 | 6.3 | 0.065 | 0.99 | −0.5₅ |
| 18 | 4.6 | 6.6 | 0.060 | 0.97 | −1.0 |

The fit of these experimental results to computed values was close enough to give a tolerable level of credence to computed results, including calculations of the intrinsic polarization-dependent gain (not allowing for modal differences in coupling efficiency) as a function of strain in the barrier layer which are shown in FIG. 4 for a bulk-strained multiple-quantum-well structure, computed by setting a negligible difference in strain levels, (curve A) and for two strained superlattice structures generally according to the examples in the table but having strains of 0 and 0.67 for the wells and barriers respectively and in which the layer thicknesses were 4 nm for the wells and 6 nm for the barrier layers (curve B) and 5 mm for each of those layers (curve C). This graph well illustrates the point that the polarization dependent gain for structures in accordance with the invention varies much less rapidly with the tension in the barrier layers than it does for the bulk-strained structure.

Computation also suggests the following rules of thumb to assist empirical adjustments to prepare additional designs of semiconductor optical amplifier in accordance with the invention:

reduction in average barrier tensile strain by about 0.04% is likely to increase the polarization dependent gain by around 0.5 dB;

increase in average well thickness by about 0.3 nm is likely to increase the polarization dependent gain by around 0.5 dB;

increase in average barrier thickness by about 0.3 nm is likely to reduce the polarization dependent gain by around 0.5 dB; and

an increase in the thickness of the confinement layer by 0.1 nm is likely to reduce the polarization dependent gain by about 0.1 dB and increase the total gain for a 1.6 mm chip length by about a third of a dB.

It is emphasized that these rules are for small changes in the neighborhood of the tabulated examples, and the extent of their applicability is uncertain.

Based on our assessment of these experiments and computations, we recommend as a preferred active core one with four substantially unstrained quantum wells of composition In_{0.53}Ga_{0.47}As each about 3-4 nm thick bounded by five barriers of InGaAs with a tensile strain of about 0.60 to 0.90% each about 5-8 nm thick.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

1. A semiconductor optical amplifier comprising an optical waveguide; an electro-optically active core within the waveguide; and electrodes for supplying electric current to said electro-optically active core to establish population inversion between energy levels therein enabling amplification of a light signal passing through the waveguide, wherein the materials and dimensions of the waveguide are chosen to obtain, at an intended working wavelength, a confinement factor of less than 0.06 for the most confined mode and mode field diameters in the range from about 3 to about 4 μm for the fundamental T_{E} and T_{M} modes, based on a 1/e mode field boundary, and wherein said electro-optically active core is constructed as a strained superlattice.

2. A semiconductor optical amplifier as claimed in claim 1 in which said electro-optically active core has a net tensile strain.

3. A semiconductor optical amplifier as claimed in claim 2 in which said electro-optically active core comprises tensile strained barriers and relatively unstrained quantum wells which are quantum-mechanically coupled.

4. A semiconductor optical amplifier as claimed in claim 3 in which there are n wells bounded by n+1 barriers, where n is about 4.

5. A semiconductor optical amplifier as claimed in claim 3 in which there are four wells bounded by five barriers.

6. A semiconductor optical amplifier as claimed in claim 3 in which said electro-optically active core comprises four substantially unstrained quantum wells of composition In_{0.53}Ga_{0.47}As each about 3-4 nm thick bounded by five barriers of InGaAs with a tensile strain of about 0.60 to 0.90% each about 5-8 nm thick.

7. A semiconductor optical amplifier as claimed in claim 1 having an overall fiber-to-fiber polarization-dependent gain less than 1 dB.

8. A semiconductor optical amplifier as claimed in claim 1 having an overall fiber-to-fiber polarization-dependent gain less than about 0.6 dB.

8. An assembly comprising a semiconductor optical amplifier as claimed in claim 1 and at least one lensed optical fiber directly coupled to the semiconductor optical amplifier without a mode expander.

9. A semiconductor optical amplifier comprising an optical waveguide; an electro-optically active core within the waveguide; and electrodes for supplying electric current to said electro-optically active core to establish population inversion between energy levels therein enabling amplification of a light signal passing through the waveguide, wherein the materials and dimensions of the waveguide are chosen to obtain, at an intended working wavelength, a confinement factor of less than 0.06 for the most confined mode and mode field diameters in the range from about 3 to about 4 μm for the fundamental T_{E} and T_{M} modes, based on a 1/e mode field boundary, whereby the semiconductor optical amplifier can be readily coupled to a lensed optical fiber without requiring a mode expander.

10. An assembly comprising a semiconductor optical amplifier comprising an optical waveguide; an electro-optically active core within the waveguide; and electrodes for supplying electric current to said electro-optically active core to establish population inversion between energy levels therein enabling amplification of a light signal passing through the waveguide, wherein the materials and dimensions of the waveguide are chosen to obtain, at an intended working wavelength, a confinement factor of less than 0.06 for the most confined mode and mode field diameters in the range from about 3 to about 4 μm for the fundamental T_{E} and T_{M} modes, based on a 1/e mode field boundary, and at least one lensed optical fiber directly coupled to the semiconductor optical amplifier without a mode expander.
